(19) United States
(12) Patent Application Publication
(10) Pub. No.: US 2026/0178043 A1
(43) Pub. Date: Jun. 25, 2026

(54) ROBOT CONTROL APPARATUS AND METHOD THEREOF

(71) Applicants: Hyundai Motor Company, Seoul (KR); Kia Corporation, Seoul (KR)

(72) Inventors: Gi Yong Park, Hwaseong-si (KR); Tae Ho Kim, Hwaseong-si (KR)

(21) Appl. No.: 19/213,659

(22) Filed: May 20, 2025

(30) Foreign Application Priority Data
Dec. 23, 2024 (KR) 10-2024-0194640

(51) Int. Cl. G05D 1/622

(52) U.S. Cl. CPC G05D 1/637

(57) ABSTRACT

In an embodiment a control apparatus includes a memory storing a computer-executable instruction and a processor, wherein the processor is configured to generate a target map based on receiving at least one unit map, to determine at least one waypoint corresponding to the at least one unit map included in the target map and to generate a driving path of a robot based on a connected graph determined based on the at least one waypoint.

### CROSS-REFERENCE TO RELATED APPLICATIONS

This application claims the benefit of priority to Korean Patent Application No. 10-2024-0194640, filed in the Korean Intellectual Property Office on Dec. 23, 2024, the entire contents of which are incorporated herein by reference.

### TECHNICAL FIELD

The present disclosure relates to a robot control apparatus and a method thereof, and more particularly, relates to technologies for determining a driving path of a robot.

### BACKGROUND

Recently, a service robot has been used in various industry and service environments and there has been an increase in its field of activity. Thus, a space where the robot operates has also expanded from a mono-layer structure to a wide mono-layer space and a multi-layer structure space. A map management and path generation technology for effectively covering it has emerged as an important issue. However, as the precision of map data is larger, there is a larger quantity of data included in the map data and there is an increase in data size in proportional to the quantity of data. More computing resources are required to process such large amounts of map data. This causes an increase in the cost of manufacturing a robot system and deterioration in marketability of the robot system.

Particularly, map data should be efficiently managed such that a robot moves in a wide region or a multi-layer structure. To this end, a scheme for dividing and managing several maps is used. However, because such a scheme is just map switching simply considering only a connection relationship of the map, it does not sufficiently reflect an actual driving environment of the robot.

To address such problems, there is a desire to develop a technology for defining a relationship between multiple maps as a weight graph to quantitatively represent connectivity between maps and inferring an optimal path for a robot to move based on the weight graph.

### SUMMARY

Embodiments may solve the above-mentioned problems occurring in the prior art while advantages achieved by the prior art may be maintained.

An embodiment of the present disclosure provides a robot control apparatus for determining at least one waypoint respectively corresponding to at least one unit map included in a target map and generating a driving path based on a connected graph to divide and manage a wide space into unit maps and generating an optimal path via a connection between maps if necessary to minimize a data processing burden and a method thereof.

Another embodiment of the present disclosure provides a robot control apparatus for calculating an optimal movement path with regard to environmental data (e.g., a location of an obstacle, a distance of a path, or the like) in a map, if moving to a final destination using a connected graph and a method thereof.

The technical problems to be solved by the present disclosure are not limited to the aforementioned problems, and any other technical problems not mentioned herein will be clearly understood from the following description by those skilled in the art to which the present disclosure pertains.

According to an embodiment of the present disclosure, a robot control apparatus may include a memory storing a computer-executable instruction and a processor that accesses the memory and executes the instruction. The processor may generate a target map via at least one unit map, based on receiving the at least one unit map, may determine at least one waypoint respectively corresponding to the at least one unit map included in the target map, and may generate a driving path of a robot, based on a connected graph determined via the at least one waypoint.

In an embodiment, the processor may identify at least one of coordinates of an obstacle included in each of the at least one unit map, location coordinates of each of the at least one unit map, or image data of each of the at least one unit map, or any combination thereof and may connect the at least one unit map, based on the at least one of the coordinates of the obstacle, the location coordinates, or the image data, or the any combination thereof.

In an embodiment, the processor may transmit an approval request to a user, after connecting at least one unit map, may generate the target map, based on receiving approval from the user, and may apply error information of the target map to the at least one unit map to generate the target map, based on receiving the error information from the user.

In an embodiment, the processor may identify a first point about a current location of the robot and a second point about a target location of the robot, based on the target map, may apply the target map, the first point, and the second point to a path prediction model trained to predict a path to obtain a temporary path, and may obtain a region of interest including a region where the robot is movable from the target map, based on the target map and the temporary path.

In an embodiment, the processor may determine a target region which is a region applied to connect the at least one unit map on the basis of the region of interest, based on a size of the robot and a function of the robot, and may determine a predetermined point of the target region as the at least one waypoint.

In an embodiment, the processor may determine the connected graph in which each of the at least one unit map is applied to a node and the at least one waypoint is applied to an edge between the nodes, based on determining the at least one waypoint.

In an embodiment, the processor may identify a reference unit map including a target location of the robot from the at least one unit map, may identify a comparison unit map adjacent to the reference unit map via the at least one waypoint, and may delete the at least one waypoint between the comparison unit map and the reference unit map, if identifying that it is impossible for the robot to move from the at least one waypoint between the comparison unit map and the reference unit map to the target location due to an obstacle included in the reference unit map.

In an embodiment, the processor may determine a weight of the edge included in the connected graph, based on at least one of a speed of the robot, energy consumption of the robot, safety of the robot, or a priority of each of the at least one unit map, or any combination thereof, and may generate the driving path, based on a path score obtained by applying the connected graph in which the weight is determined to a predetermined path algorithm.

In an embodiment, the processor may control the robot to be able to move along the driving path, based on generating the driving path, may receive obstacle information identified while the robot is moving to perform an update of the target map, and may determine the at least one waypoint again, based on the target map, the update of which is performed.

In an embodiment, the processor may determine a target layer among a plurality of layers included in a multi-layer structure, if the at least one unit map is about the multi-layer structure, and may connect at least one map about the target layer among the at least one unit map to generate the target map.

According to another aspect of the present disclosure, a robot control method may include generating a target map via at least one unit map, based on receiving the at least one unit map, determining at least one waypoint respectively corresponding to the at least one unit map included in the target map, and generating a driving path of a robot, based on a connected graph determined via the at least one waypoint.

In an embodiment, the generating of the driving path of the robot may include identifying at least one of coordinates of an obstacle included in each of the at least one unit map, location coordinates of each of the at least one unit map, or image data of each of the at least one unit map, or any combination thereof and connecting the at least one unit map, based on the at least one of the coordinates of the obstacle, the location coordinates, or the image data, or the any combination thereof.

In an embodiment, the generating of the driving path of the robot may include transmitting an approval request to a user, after connecting at least one unit map, generating the target map, based on receiving approval from the user, and applying error information of the target map to the at least one unit map to generate the target map, based on receiving the error information from the user.

In an embodiment, the generating of the driving path of the robot may include identifying a first point about a current location of the robot and a second point about a target location of the robot, based on the target map, applying the target map, the first point, and the second point to a path prediction model trained to predict a path to obtain a temporary path, and obtaining a region of interest including a region where the robot is movable from the target map, based on the target map and the temporary path.

In an embodiment, the generating of the driving path of the robot may include determining a target region which is a region applied to connect the at least one unit map on the basis of the region of interest, based on a size of the robot and a function of the robot, and determining a predetermined point of the target region as the at least one waypoint.

In an embodiment, the generating of the driving path of the robot may include determining the connected graph in which each of the at least one unit map is applied to a node and the at least one waypoint is applied to an edge between the nodes, based on determining the at least one waypoint.

In an embodiment, the generating of the driving path of the robot may include identifying a reference unit map including a target location of the robot from the at least one unit map, identifying a comparison unit map adjacent to the reference unit map via the at least one waypoint, and deleting the at least one waypoint between the comparison unit map and the reference unit map, if identifying that it is impossible for the robot to move from the at least one waypoint between the comparison unit map and the reference unit map to the target location due to an obstacle included in the reference unit map.

In an embodiment, the generating of the driving path of the robot may include determining a weight of the edge included in the connected graph, based on at least one of a speed of the robot, energy consumption of the robot, safety of the robot, or a priority of each of the at least one unit map, or any combination thereof, and generating the driving path, based on a path score obtained by applying the connected graph in which the weight is determined to a predetermined path algorithm.

In an embodiment, the generating of the driving path of the robot may include controlling the robot to be able to move along the driving path, based on generating the driving path, receiving obstacle information identified while the robot is moving to perform an update of the target map, and determining the at least one waypoint again, based on the target map, the update of which is performed.

In an embodiment, the generating of the driving path of the robot may include determining a target layer among a plurality of layers included in a multi-layer structure, if the at least one unit map is about the multi-layer structure, and connecting at least one map about the target layer among the at least one unit map to generate the target map.

### BRIEF DESCRIPTION OF THE DRAWINGS

The above and other objects, features and advantages of the present disclosure will be more apparent from the following detailed description taken in conjunction with the accompanying drawings:

FIG. 1 is a drawing illustrating a block diagram of a robot control apparatus according to an embodiment of the present disclosure;

FIG. 2 is a flowchart for describing a robot control method according to an embodiment of the present disclosure;

FIG. 3 is a drawing illustrating an example of a unit map;

FIG. 4 is a drawing illustrating an example of a target map generated from a unit map;

FIG. 5 is a drawing illustrating an example of a region of interest obtained from a target map;

FIG. 6 is a drawing illustrating an example of a target region for determining a waypoint;

FIG. 7 is a drawing illustrating an example of a waypoint determined from a target region;

FIG. 8 is a drawing illustrating an example of a connected graph determined via a waypoint, in a robot control apparatus according to an embodiment of the present disclosure;

FIG. 9 is a drawing illustrating an example of a connected graph determined via a waypoint, in a robot control apparatus according to an embodiment of the present disclosure;

FIG. 10 is a drawing illustrating an example of an item applied to an operation of obtaining a path score, in a robot control apparatus according to an embodiment of the present disclosure;

FIG. 11 is a flowchart for describing a robot control method, in a robot control apparatus according to an embodiment of the present disclosure; and

FIG. 12 is a drawing illustrating a computing system associated with a robot control apparatus or a robot control method according to an embodiment of the present disclosure.

With regard to description of drawings, the same or similar denotations may be used for the same or similar components.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical component is designated by the identical numerals even when they are displayed on other drawings. Further, in describing the embodiment of the present disclosure, a detailed description of well-known features or functions will be ruled out in order not to unnecessarily obscure the gist of the present disclosure. Particularly, various embodiments of the present disclosure may be described with reference to the accompanying drawings. However, it should be understood that this is not intended to limit the present disclosure to specific implementation forms and includes various modifications, equivalents, and/or alternatives of embodiments of the present disclosure. With regard to description of drawings, similar components may be marked by similar reference numerals.

In describing components of exemplary embodiments of the present disclosure, the terms first, second, A, B, (a), (b), and the like may be used herein. These terms are only used to distinguish one component from another component, but do not limit the corresponding components irrespective of the order or priority of the corresponding components. Furthermore, unless otherwise defined, all terms including technical and scientific terms used herein have the same meaning as being generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application. For example, the terms, such as “first”, “second”, “1st”, “2nd”, or the like used in the present disclosure may be used to refer to various components regardless of the order and/or the priority and to distinguish one component from another component, but do not limit the components. For example, “a first user device” and “a second user device” may indicate different user devices regardless of the order or priority thereof. For example, without departing the scope of the present disclosure, a first component may be referred to as a second component, and similarly, a second component may be referred to as a first component.

In the present disclosure, the expressions “have”, “may have”, “include” and “comprise”, or “may include” and “may comprise” indicate existence of corresponding features (e.g., components such as numeric values, functions, operations, or parts), but do not exclude presence of additional features.

It will be understood that when a component (e.g., a first component) is referred to as being “(operatively or communicatively) coupled with/to” or “connected to” another component (e.g., a second component), it can be directly coupled with/to or connected to the other component or an intervening component (e.g., a third component) may be present. In contrast, when a component (e.g., a first component) is referred to as being “directly coupled with/to” or “directly connected to” another component (e.g., a second component), it should be understood that there is no intervening component (e.g., a third component).

According to the situation, the expression “configured to” used in the present disclosure may be used exchangeably with, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs which store a dedicated processor (e.g., an embedded processor) for performing a corresponding operation or a memory device. Terms used in the present disclosure are used to describe specified embodiments and are not intended to limit the scope of another embodiment. The terms of a singular form may include plural forms unless the context clearly indicates otherwise. All the terms used herein, which include technical or scientific terms, may have the same meaning that is generally understood by a person skilled in the art described in the present disclosure. It will be further understood that terms, which are defined in a dictionary and commonly used, should also be interpreted as is customary in the relevant related art and not in an idealized or overly formal detect unless expressly so defined herein in various embodiments of the present disclosure. In some cases, even if terms are terms which are defined in the present disclosure, they may not be interpreted to exclude embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. Particularly, the phrase such as “at least one of A, B, or C, or any combination thereof” may include “A”, “B”, or “C”, or “AB” or “ABC”, which is a combination thereof.

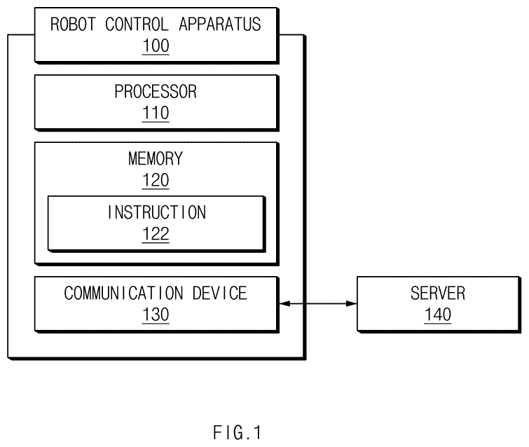

Hereinafter, embodiments of the present disclosure will be described in detail with reference to FIGS. 1 to 12.

FIG. 1 is a drawing illustrating a block diagram of a robot control apparatus according to an embodiment of the present disclosure.

A robot control apparatus 100 according to an embodiment may include a processor 110, a memory 120 including an instruction 122, and a communication device 130.

The robot control apparatus 100 may indicate a device which determines a driving path of a robot, based on a connected graph corresponding to a target map generated from a unit map.

The robot control apparatus 100 may generate an optimal driving path based on the unit map and may control the robot. The robot control apparatus 100 may optimize the driving path of the robot via efficient management and connection of map data and may flexibly operate in various environments.

The robot control apparatus 100 may receive the unit maps and may connect the unit maps to generate the target map. A waypoint may be determined on each unit map included in the generated target map. The robot control apparatus 100 may generate a connected graph using the waypoint. As a result, the robot control apparatus 100 may generate a driving path for the robot to move to a final destination.

The robot control apparatus 100 may identify various pieces of environmental data, such as obstacle coordinates in a map, location coordinates in the map, or image data in the map and may connect the unit maps based on them. At this time, the robot control apparatus 100 may request approval of a user in the map connection process and may apply error correction information to correct the target map.

The robot control apparatus 100 may obtain a temporary path using a path prediction model based on a current location and a target location of the robot and may set a region of interest. The robot control apparatus 100 may determine a movable target region depending on a size and a function of the robot and may set a specific point of the target region as the waypoint to increase accuracy of the driving path.

The robot control apparatus 100 may determine the waypoint, may construct a relationship between the unit maps using a node and an edge on the connected graph, and may assign a weight to each edge with regard to an element, such as a speed of the robot, energy consumption of the robot, safety of the robot, a priority, or the like. The robot control apparatus 100 may calculate an optimal path of the robot via a path algorithm, based on the connected graph to which the weight is assigned.

The robot control apparatus 100 may identify obstacle information in real time, while the robot is moving, and may reflect the obstacle information in the target map to continuously update the target map. The robot control apparatus 100 may reset the waypoint depending on the updated target map to quickly respond to an environmental change and optimize the path.

The robot control apparatus 100 may flexibly operate even in a multi-layer structure environment. The robot control apparatus 100 may select a target layer among a plurality of layers in a multi-layer structure and may connect unit maps of the target layer to generate a driving path for the multi-layer structure.

The robot control apparatus 100 may efficiently manage map data, may calculate an optimal path via the connected graph, and may implement an advanced robot control system corresponding to a real-time environmental change. As a result, the robot may stably and precisely drive in various environments.

The processor 110 may execute software and may control at least one other component (e.g., a hardware or software component) connected with the processor 110. In addition, the processor 110 may perform a variety of data processing or computation. For example, the processor 110 may store the unit map, the target map, the waypoint, the connected graph, or the like in the memory 120.

For reference, the processor 110 may perform all operations performed by the robot control apparatus 100. Therefore, for convenience of description in the specification, the operation performed by the robot control apparatus 100 is mainly described as an operation performed by the processor 110. Furthermore, for convenience of description in the specification, the processor 110 is mainly described as, but not limited to, one processor. For example, the robot control apparatus 100 may include processors. Each of the processors may perform all operations associated with an operation of generating a driving path.

The memory 120 may temporarily and/or permanently store various pieces of data and/or information required to perform the operation of generating the driving path of the robot. For example, the memory 120 may store the unit map, the target map, the waypoint, the connected graph, or the like.

The communication device 130 may assist in performing communication between the robot control apparatus 100 and a server 140. For example, the communication device 130 may include one or more components for performing communication between the robot control apparatus 100 and the server 140. For example, the communication device 130 may include a short range wireless communication unit, a microphone, or the like. At this time, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like. A reception operation among the operations of the robot control apparatus 100 in the specification may include an operation of receiving data (e.g., a unit map) from the server 140.

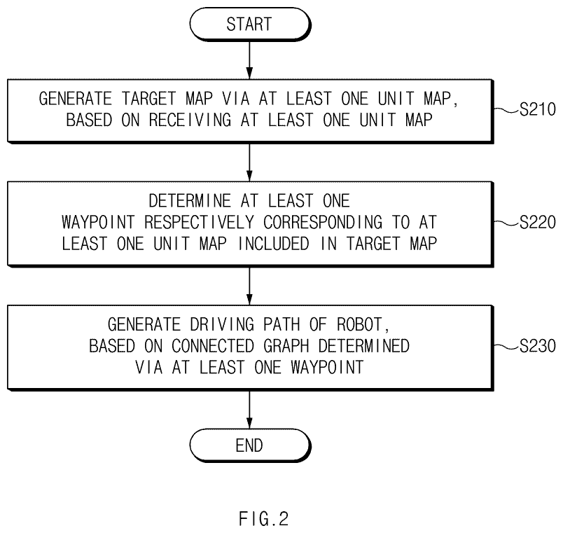

FIG. 2 is a flowchart for describing a robot control method according to an embodiment of the present disclosure.

In S210, a processor (e.g., a processor 110 of FIG. 1) according to an embodiment may generate a target map via at least one unit map, based on receiving the at least one unit map.

For example, the unit map may refer to map data for a specific region or a specific zone. The unit map may be the result of dividing a map into several small units to effectively manage a wide space, which may include specific coordinates, obstacle information, image data, or the like.

For example, the target map may refer to integrated map data generated by connecting a plurality of unit maps. The target map may provide the entire path and environmental information necessary for the robot to move to a final destination and may be generated by reflecting a relationship between the unit maps.

In S220, the processor may determine at least one waypoint respectively corresponding to the at least one unit map included in the target map.

For example, the waypoint may refer to a specific point through which the robot should passes on the driving path. The waypoint may be used as a connection point between the unit maps or a reference point at which the robot switches a direction or changes a target path at a specific location.

In S230, the processor may generate a driving path of the robot, based on a connected graph determined via the at least one waypoint.

For example, the connected graph may refer to a graph structure representing a relationship between the plurality of unit maps and the waypoint as a node and an edge. The unit map in the connected graph may be applied to a node and the waypoint in the connected graph may be applied to an edge which is a connection between the nodes. The connected graph may be used to define a path along which the robot is movable and calculate an optimal path.

For example, the driving path may refer to an optimal path for the robot to move from a current location and to the target location based on the connected graph. The driving path may be generated with regard to a speed, energy consumption, safety, obstacle information, or the like of the robot and may be updated, if an environmental change is detected while the robot is driving.

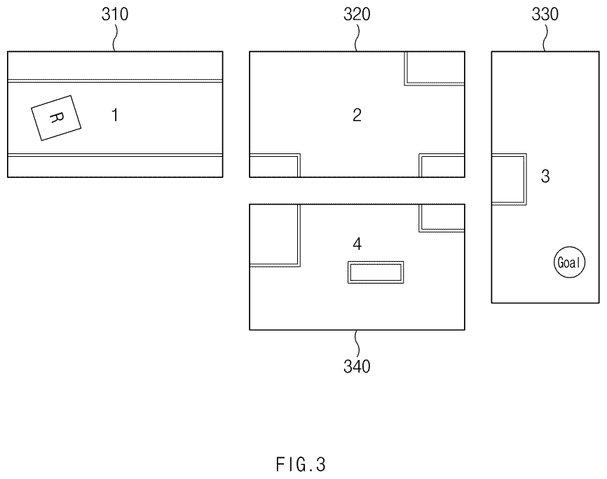

FIG. 3 is a drawing illustrating an example of a unit map.

FIG. 3 illustrates an example of a first unit map 310, a second unit map 320, a third unit map 330, and a fourth unit map 340. Each unit map may indicate a specific region.

For example, the first unit map 310 may be data for a specific space, which may include a point of interest (POI), an obstacle, or an initial location of a robot. Obstacle data and specific image data may be identified in the first unit map 310. The first unit map 310 may be used to determine a movement starting point or a waypoint of the robot.

The second unit map 320 may indicate data for an adjacent region capable of being connected with the first unit map 310. The second unit map 320 may include coordinates of an obstacle and boundary information of a space and may act on a reference point for identifying a path along which the robot is movable. Illustratively, a processor may set a waypoint to form a path and may define a relationship with an adjacent unit map via a connected graph.

The third unit map 330 may indicate a region including a final destination (“Goal”). The destination (i.e., “Goal”) shown in FIG. 3 may indicate a final target location to which the robot should move. The processor may identify a path along which the robot is movable, using coordinates and location data of the obstacle included in the third unit map 330.

The fourth unit map 340 may indicate another region connected with the second unit map 320. The fourth unit map 340 may include an obstacle in a space and environmental data and may be used as a portion of the connected graph.

The processor may connect the first unit map 310, the second unit map 320, the third unit map 330, and the fourth unit map 340, which are shown in FIG. 3, to generate a movement path of the robot. The processor may identify obstacle coordinates, location coordinates, and image data included in each unit map. The processor may set a connection relationship between the respective unit maps based on the identified data and may determine a waypoint. The processor may form a connected graph between the respective unit maps via the waypoint and may calculate an optimal driving path. In detail, the processor may generate a movement path from a starting location of the robot to the final destination on the basis of a target point included in the third unit map 330.

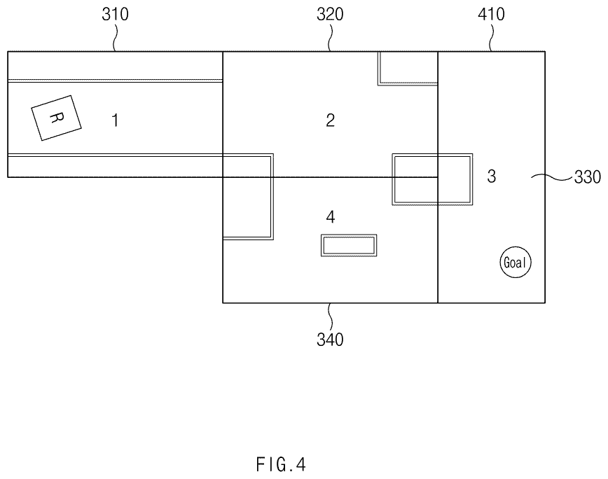

FIG. 4 is a drawing illustrating an example of a target map generated from a unit map.

FIG. 4 is a drawing illustrating an example of a target map 410 generated by connecting at least one unit map shown in FIG. 3. In FIG. 4, an example of connecting a first unit map 310, a second unit map 320, a third unit map 330, and a fourth unit map 340 to form one target map 410 is illustrated.

The target map 410 may refer to an integrated map generated by connecting a plurality of unit maps. The target map 410 may include a connection relationship necessary for a robot to move from a current location to a final destination.

The first unit map 310 is a space capable of including a starting point or an initial location of the robot. The first unit map 310 includes an obstacle and a space boundary and may be connected with the second unit map 320 via a waypoint. The second unit map 320 is a region connected with the first unit map 310, which may play a role as an intermediate transit. The third unit map 330 is a region including a final destination Goal, which is a space where a target point of the robot is located. The third unit map 330 may be in a state in which it is connected with the second unit map 320. The robot may move to the final destination along the waypoint. The fourth unit map 340 is another region connected with the second unit map 320, which may include another path through which the robot is able to pass.

The processor may identify obstacle coordinates, location coordinates, and image data included in each of unit maps. The processor may connect the unit maps to generate the target map 410. In this process, the processor may automatically estimate a relationship between maps on the basis of a location of the obstacle and a coordinate system, via an automatic connection scheme, to generate the target map 410. Illustratively, the automatic connection scheme may indicate a scheme which automatically estimates a connection relationship of the map, via an algorithm for determining the location of the obstacle, the coordinate system, and a similarity of image data of the map.

The processor may correct an error in map, which occurs after connecting the unit maps, via a manual connection scheme. Illustratively, the manual connection scheme may indicate a scheme which manually corrects an error in map by a user.

The processor may connect at least one unit map and may transmit an approval request to the user. The processor may generate the target map 410, based on receiving approval from the user. Based on receiving error information of the target map 410 (i.e., information for correcting the error in map by the user) from the user, the processor may apply the error information to at least one unit map to generate a target map (i.e., a target map in which the error is corrected).

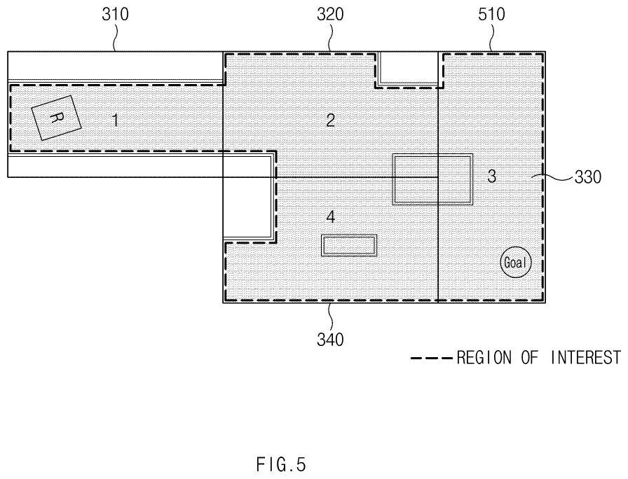

FIG. 5 is a drawing illustrating an example of a region of interest obtained from a target map.

FIG. 5 is a drawing illustrating a process of discriminating a region where a robot is movable based on a target map in a processor (e.g., a processor 110 of FIG. 1) according to an embodiment. FIG. 5 illustrates a target map in which a first unit map 310, a second unit map 320, a third unit map 330, and a fourth unit map 340 are connected with one another and illustrates a region of interest 510 including a region where a robot is movable.

The region of interest 510 is calculated on the basis of footprint data of the robot and a keep-out region and is set to a region where the robot is able to move without colliding with an obstacle.

A location in the first unit map 310 indicates a current location of the robot and “Goal” of the third unit map 330 indicates a target location to which the robot should move. The processor may identify a current location (i.e., a first point) of the robot and a target location (i.e., a second point) of the robot based on the target map. The processor may generate a temporary path using a path prediction model and may obtain the region of interest 510 where the robot is movable based on the temporary path. Herein, the region of interest 510 may indicate a region where the robot is substantially drivable and may be criteria for path optimization.

The region of interest 510 may include a safe region where the robot is movable by reflecting coordinates of an obstacle and a space boundary. Illustratively, the processor may identify the first point about the current location of the robot (e.g., the location of the robot shown in the first unit map 310 in FIG. 5) and the second point about the target location of the robot (e.g., the location of “Goal” shown in the third unit map 330 in FIG. 5), based on the target map. The processor may apply the target map, the first point, and the second point to the path prediction model trained to predict a path, thus obtaining the temporary path. The processor may obtain the region of interest 510 including a region where the robot is movable from the target map, based on the target map and the temporary path. In other words, the temporary path may indicate a path generated based on all regions where the robot is movable on the target map.

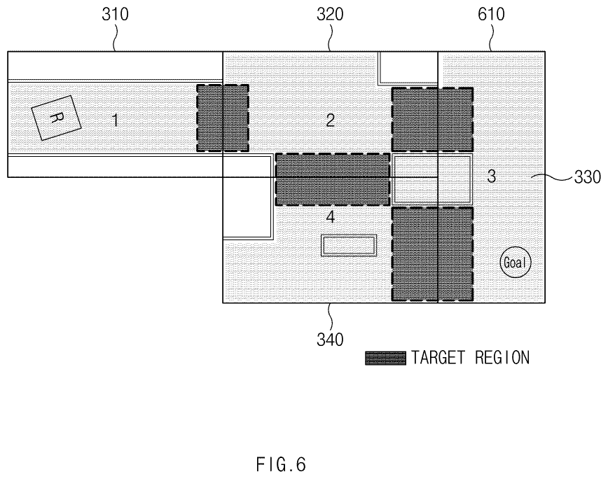

FIG. 6 is a drawing illustrating an example of a target region for determining a waypoint.

FIG. 6 is a drawing illustrating a process of determining a possibility of a connection between unit maps with regard to a size and a function of a robot on the basis of a region of interest in a processor (e.g., a processor 110 of FIG. 1) according to an embodiment.

The connection region shown in FIG. 6 indicates a target region where a connection possibility is finally determined on a target map 610. The target region is a portion where it is possible to perform an actual connection between unit maps in the region of interest and is determined as a region where a size and a function of the robot are satisfied.

The processor may identify the size of the robot on the basis of a width of a movable path or a physical obstacle. The processor may identify the function (e.g., stair climbing, obstacle avoidance, or the like) of the robot, based on whether the robot is able to pass through a specific environment in the target region.

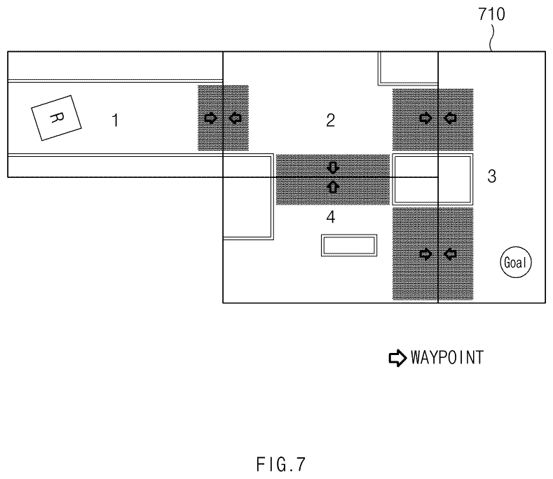

FIG. 7 is a drawing illustrating an example of a waypoint determined from a target region.

FIG. 7 is a drawing illustrating a process of determining a location of a waypoint in a target region in a processor (e.g., a processor 110 of FIG. 1) according to an embodiment.

The waypoint is a point set at a location where a robot is safest to move in the target region. The waypoint may be set at the most middle location of the target region, but may be corrected in location according to an intention of a manager or an environmental condition. For example, if the robot should bypass an obstacle or more safely should pass through a specific location, the manager may adjust the waypoint.

The processor may determine a predetermined point of the target region on a target map 710 as at least one waypoint. Illustratively, an arrow shown in FIG. 7 may indicate a location of the waypoint and a direction through which a robot should pass.

The processor may identify a reference unit map (e.g., a third unit map in FIG. 7) including a target location of the robot from at least one unit map. The processor may identify a comparison unit map (e.g., a second unit map or a fourth unit map in FIG. 7) adjacent to the reference unit map via the waypoint. If identifying that it is impossible for the robot to move from a waypoint between the comparison unit map and the reference unit map to a target location (i.e., “Goal” shown in FIG. 7) due to an obstacle included in the reference unit map, the processor may delete the waypoint between the comparison unit map and the reference unit map.

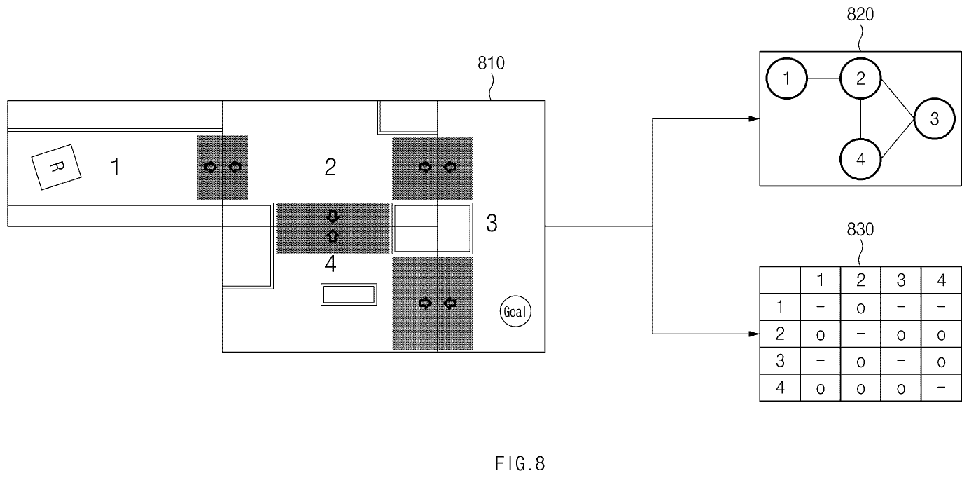

FIG. 8 is a drawing illustrating an example of a connected graph determined via a waypoint, in a robot control apparatus according to an embodiment of the present disclosure.

FIG. 8 is an exemplary drawing for describing a process of generating a connected graph 820 and an adjacent matrix 830 based on a target map 810.

The target map 810 is an integrated map connecting a plurality of unit maps (e.g., a first unit map 310, a second unit map 320, a third unit map 330, and a fourth unit map 340 of FIG. 3). A waypoint may be set in the target map 810 and indicates a movable path between the respective unit maps. The waypoint may be an important reference point indicating a connection between unit maps, which may play a role as an intermediate point of a path along which a robot should move.

The connected graph 820 is a graph structure which represents each unit map as a node and represents the waypoint as an edge on the target map 810. Illustratively, node 1 may correspond to the first unit map 310, node 2 may correspond to the second unit map 320, node 3 may correspond to the third unit map 330, and node 4 may correspond to the fourth unit map 340. The edge indicates a relationship between unit maps connected via the waypoint and is represented as a line on the graph. Illustratively, node 1 and node 2 is in a state in which they are connected via the waypoint and node 2 is connected with node 3 and node 4.

The adjacent matrix 830 is a data structure in which the connected graph 820 is numerically represented. Each row and column of the adjacent matrix 830 indicates a unit map and displays whether there is a connection in number (e.g., 0 or 1). Illustratively, “1” indicates that there is a connection between unit maps and “0” indicates that there is no connection between unit maps. In detail, because node 1 and node 2 are connected with each other, “1” is displayed at positions of “(1, 2)” and “(2, 1)” and “0” is displayed between nodes which are not connected with each other.

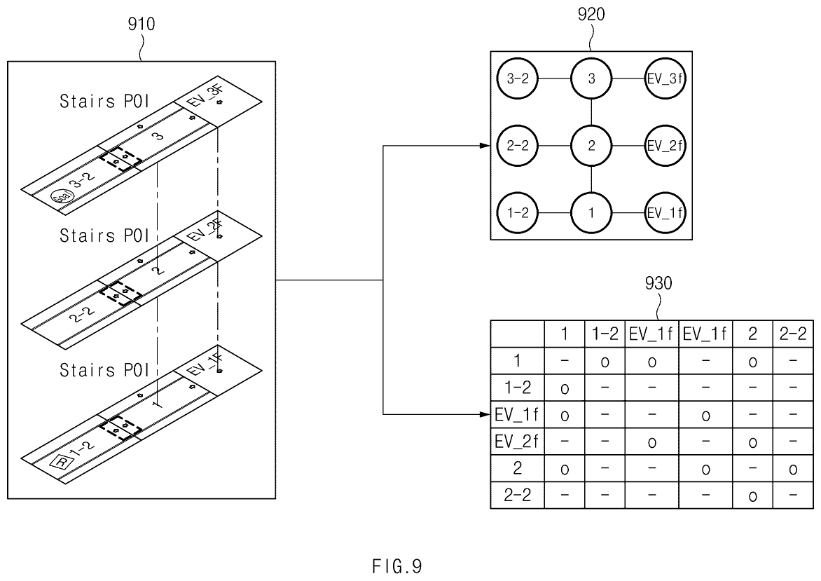

FIG. 9 is a drawing illustrating an example of a connected graph determined via a waypoint, in a robot control apparatus according to an embodiment of the present disclosure.

FIG. 9 is an exemplary drawing for describing a process of generating a connected graph 920 and an adjacent matrix 930 based on a target map 910.

The target map 910 is an integrated map connecting a plurality of unit maps. A waypoint may be set in the target map 910 and indicates a movable path between the respective unit maps. The waypoint may be an important reference point indicating a connection between unit maps, which may play a role as an intermediate point of a path along which a robot should move.

The connected graph 920 is a graph structure which represents each unit map as a node and represents the waypoint as an edge on the target map 910. Illustratively, node 1 may correspond to a unit map of a first layer, node 2 may correspond to a unit map of a second layer, and node 3 may correspond to a unit map of a third layer. The edge indicates a relationship between unit maps connected via the waypoint and is represented as a line on the graph. Illustratively, node 1 and node 2 are in a state in which there are connected with each other via the waypoint and node 2 is connected with node 1 and node 3.

The adjacent matrix 930 is a data structure in which the connected graph 920 is numerically represented. Each row and column of the adjacent matrix 930 indicates a unit map and displays whether there is a connection in number (e.g., 0 or 1). Illustratively, “1” indicates that there is a connection between unit maps and “0” indicates that there is no connection between unit maps.

If at least one unit map is about a multi-layer structure, the processor may determine a target layer among a plurality of layers included in the multi-layer structure. For example, the target layer may be one of the first layer, the second layer, or the third layer. The processor may connect at least one map about the target layer among the at least one unit map to generate the target map 910.

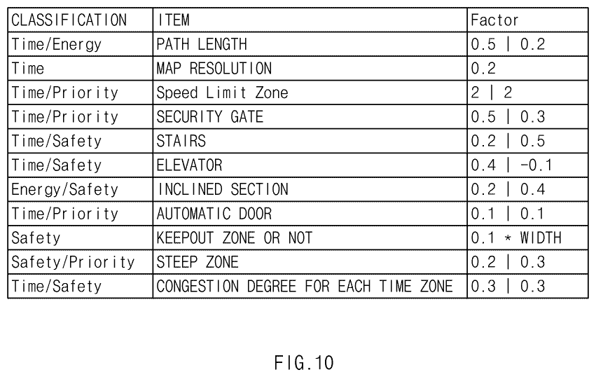

FIG. 10 is a drawing illustrating an example of an item applied to an operation of obtaining a path score, in a robot control apparatus according to an embodiment of the present disclosure.

A processor (e.g., a processor 110 of FIG. 1) according to an embodiment may obtain a path score to generate a driving path.

The processor may determine a weight of an edge included in a connected graph, based on at least one of a speed of a robot, energy consumption of the robot, safety of the robot, or a priority of each of at least one unit map, or any combination thereof. The processor may generate a driving path, based on a path score obtained by applying the connected graph in which the weight is determined to a predetermined path algorithm (e.g., a Dijkstra algorithm).

The weight of the edge may be represented by Equation 1 below.

$$W = α \times {W}_{time} + β \times {W}_{energy} + γ \times {W}_{safety} + δ \times {W}_{priority} \qquad [ Equation 1 ]$$

Herein, W may refer to the weight of the edge, α, β, γ, [symbol] δ may refer to the factor for adjusting the importance of each element, Wₜᵢₘₑ may refer to the time weight, W_{energy} may refer to the energy weight, W_{safety} may refer to the safety weight, and W_{priority} may refer to the priority region weight.

For example, if the weight of the edge indicates a weight of an edge connecting node 2 and node 4, the processor may determine the weight of the edge, based on a speed (i.e., a time weight) of the robot between node 2 and node 4, energy consumption (i.e., an energy weight) of the robot, safety (i.e., a safety weight) of the robot, a priority (i.e., a priority region weight) of each of the nodes.

For example, if a path length between node 1 and node 2 is “11 m” and there is a speed limit zone in node 4 (i.e., binary “1” if there is the speed limit section and binary “o” if there is no speed limit section), the processor may obtain a time weight as follows. In detail, the processor may apply “0.5” of a “Time” element among items about a “path length” in the table shown in FIG. 10 to “11 m”. The processor may apply “2” of the “Time” element about items about a “Speed Limit Zone” in the table shown in FIG. 10 to “1”. As a result, the processor may determine the sum, “7.5”, of the value obtained by applying “0.5” to “11 m” and the value obtained by applying “2” to “1” as a time weight between node 2 and node 4.

The path length refers to a distance a robot should move. The path length has an influence on time and the energy weight. “0.5” and “0.2” indicate degrees to which the path length has an influence on each weight. Map resolution refers to precision of map data and has an influence on a weight for time. As the precision is larger, larger calculation time is required to generate a path.

The speed limit zone indicates a specific region where the robot is limited to a movement speed. The speed limit zone has an influence on time and priority and reflects a speed constraint upon path optimization. A security gate refers to a zone where it takes time or there is restriction if passing through a specific zone. The security gate is used to adjust weights for time and priority.

Stairs are an element which has an influence on safety and time if the robot moves. A weight is set with regard to a function of the robot (e.g., whether the robot climbs stairs) and an environmental condition. An elevator is an element which has an influence on time and safety, and requires a movement time, but may allow the robot to safely perform interlayer movement. “−0.1” means the elevator is rather advantageous in terms of safety.

An inclined section has an influence on energy consumption and safety of the robot. There may be an increase in much energy consumption or the inclined section. An automatic door has an influence on time and priority and considers a time delay which occurs if the robot passes through a correspond region. A keep-out zone refers to a risk zone the robot should not enter. The keep-out zone may adjust a weight based on safety and the width of the zone may act on an important element.

A steep zone is a section where it is difficult for the robot to move and has an influence on safety and priority. The steep zone may avoid the risk zone or may optimize a path, via a weight setting. A congestion degree for each time zone refers to a congestion state of a movement path in a specific time zone. The congestion degree for each time zone has an influence on time and safety at the same time and should be considered upon movement optimization of the robot.

However, the weight of the edge is not limited thereto. For example, the weight of the edge may be determined by Equations 2 to 4 below.

The time weight may be represented by Equation 2 below.

$${W}_{time} = \frac{D}{S} \times {T}_{factor} \qquad [ Equation 2 ]$$

Herein, D may refer to the length of the path, S may refer to the average speed of the robot, and T_{fractor} may be the value of “factor” about the “time” shown in FIG. 10.

The energy weight may be represented by Equation 3 below.

$${W}_{energy} = {E}_{consumption} \times {E}_{factor} \qquad [ Equation 3 ]$$

Herein, E_{consumption} may refer to the energy consumption considering the movement distance and the consumption efficiency of the robot and E_{factor} may be the value of the “factor” about the “energy” shown in FIG. 10.

The safety weight may be represented by Equation 4 below.

$${W}_{safety} = {S}_{risk} \times {S}_{factor} \qquad [ Equation 4 ]$$

Herein, Sᵣᵢₛₖ may refer to the value obtained by evaluation the risk of the path with regard to the risk of drop-off in the path, the obstacle, and the like and S_{factor} may be the value of the “factor” about the “safety” shown in FIG. 10.

The priority region weight may be represented as Equation 5 below.

$${W}_{priority} = \frac{1}{P + 1} \times {P}_{factor} \qquad [ Equation 5 ]$$

Herein, P may refer to the priority information of the unit map and P_{factor} may be the value of the “factor” about the “priority” shown in FIG. 10.

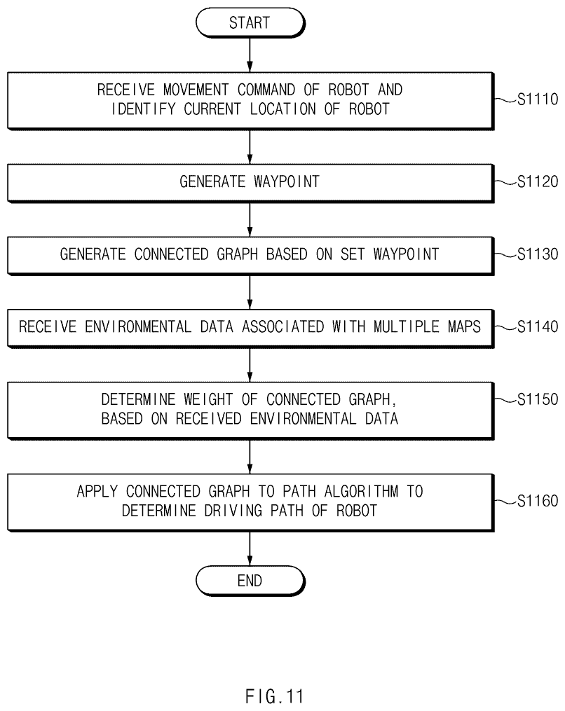

FIG. 11 is a flowchart for describing a robot control method, in a robot control apparatus according to an embodiment of the present disclosure.

In S1110, a processor (e.g., a processor 110 of FIG. 1) according to an embodiment may receive a movement command of a robot and may identify a current location of the robot. The processor may identify an initial location and a target location of the robot and may obtain default information for movement.

In S1120, the processor may generate a waypoint on the basis of a movable region on a target map. Herein, the waypoint may be set to a reference point of a connection between unit maps and may be determined as the safest and most efficient location for the robot to move.

In S1130, the processor may generate a connected graph based on the set waypoint. In this operation, the processor may apply each unit map to a node and may apply the waypoint to an edge between the nodes. The connected graph may define a relationship between unit maps and may be the structural basis of movement path calculation.

In S1140, the processor may receive environmental data associated with multiple maps. The environmental data may include obstacle coordinates, a unit map location, image data, a gradient, and a weight determination element (i.e., a “factor” shown in FIG. 10) determined based on a specific POI (e.g., stairs, an elevator, or the like).

In S1150, the processor may determine a weight of the connected graph based on the received environmental data. The weight may be set with regard to a speed of the robot, energy consumption of the robot, safety of the robot, a priority, or the like and may be applied to each edge. The method for determining the weight may be the same as the method described in FIG. 10.

In S1160, the processor may apply the connected graph to which the weight is applied to a path algorithm (e.g., Dijkstra or A*) to determine a driving path of the robot. The generated driving path may be optimized such that the robot is able to safely and efficiently move from a current location to a target location.

The processor may control the robot to be able to move along the driving path, based on generating the driving path. The processor may receive obstacle information identified while the robot is moving, thus performing an update of the target map. The processor may determine the waypoint again, based on the target map, the update of which is performed.

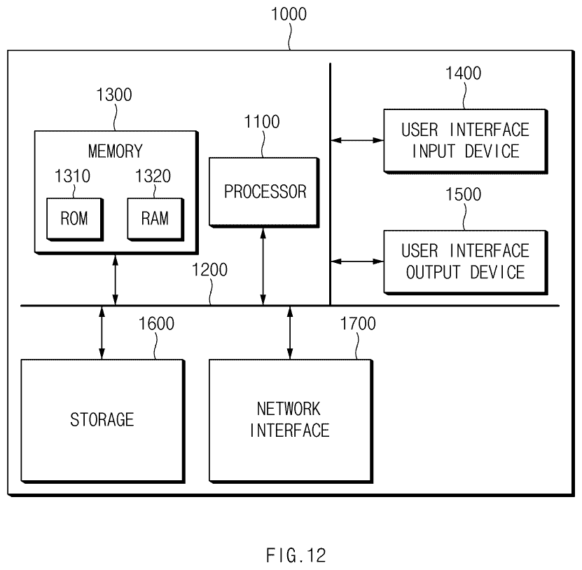

FIG. 12 is a drawing illustrating a computing system associated with a robot control apparatus or a robot control method according to an embodiment of the present disclosure.

Referring to FIG. 12, a computing system 1000 about the robot control apparatus or the robot control method may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage module 1600) such as a RAM, a flash memory, a ROM, an EPROM, an EEPROM, a register, a hard disc, a removable disk, and a CD-ROM.

The exemplary storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it may be obviously to one skilled in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description will be given of effects of the robot control apparatus and the method thereof according to an embodiment of the present disclosure.

According to at least one of embodiments of the present disclosure, the robot control apparatus may determine at least one waypoint respectively corresponding to at least one unit map included in a target map and may generate a driving path based on a connected graph to divide and manage a wide space into unit maps and may generate an optimal path via a connection between maps if necessary to minimize a data processing burden.

Furthermore, according to at least one of embodiments of the present disclosure, the robot control apparatus may calculate an optimal movement path with regard to environmental data (e.g., a location of an obstacle, a distance of a path, or the like) in a map, if moving to a final destination using the connected graph.

In addition, various effects ascertained directly or indirectly through the present disclosure may be provided.

Therefore, other implements, other embodiments, and equivalents to claims are within the scope of the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A control apparatus comprising:
a memory storing a computer-executable instruction; and
a processor configured to access the memory and execute the instruction, wherein the processor is configured to:
generate a target map based on receiving at least one unit map;
determine at least one waypoint corresponding to the at least one unit map included in the target map; and
generate a driving path of a robot based on a connected graph determined based on the at least one waypoint.

2. The control apparatus of claim 1, wherein the processor is configured to:
identify at least one of coordinates of an obstacle included in each of the at least one unit map, location coordinates of each of the at least one unit map, image data of each of the at least one unit map, or a combination thereof; and
connect the at least one unit map based on the at least one of the coordinates of the obstacle, the location coordinates, the image data, or the combination thereof.

3. The control apparatus of claim 2, wherein the processor is configured to:
after connecting at least two unit maps, transmit an approval request to a user;
generate the target map based on receiving approval from the user; and
apply error information of the target map to the at least one unit map to generate the target map based on receiving the error information from the user.

4. The control apparatus of claim 1, wherein the processor is configured to:
identify a first point about a current location of the robot and a second point about a target location of the robot based on the target map;
apply the target map, the first point, and the second point to a path prediction model trained to predict a path to obtain a temporary path; and
obtain a region of interest from the target map to which the robot is movable based on the target map and the temporary path.

5. The control apparatus of claim 4, wherein the processor is configured to:
determine a target region which is a connection region of at least two unit maps based on the region of interest and based on a size of the robot and a function of the robot; and
determine a predetermined point of the target region as the at least one waypoint.

6. The control apparatus of claim 1, wherein the processor is configured to determine the connected graph in which each of the at least one unit map is applied to a node and the at least one waypoint is applied to an edge between the nodes based on determining the at least one waypoint.

7. The control apparatus of claim 6, wherein the processor is configured to:
identify a reference unit map including a target location of the robot from the at least one unit map;
identify a comparison unit map adjacent to the reference unit map via the at least one waypoint; and
delete the at least one waypoint between the comparison unit map and the reference unit map based on identifying that it is impossible for the robot to move from the at least one waypoint between the comparison unit map and the reference unit map to the target location based on an obstacle included in the reference unit map.

8. The control apparatus of claim 6, wherein the processor is configured to:
determine a weight of the edge included in the connected graph based on at least one of a speed of the robot, energy consumption of the robot, safety of the robot, a priority of each of the at least one unit map, or a combination thereof; and
generate the driving path based on a path score obtained by applying the connected graph in which the weight is determined to a predetermined path algorithm.

9. The control apparatus of claim 1, wherein the processor is configured to:
control the robot to move along the driving path based on generating the driving path;
receive obstacle information for performing an update of the target map;
re-determine the at least one waypoint based on the target map; and
performing the update.

10. The control apparatus of claim 1, wherein the processor is configured to:
determine a target layer among a plurality of layers for at least two unit maps; and
connect the at least two maps for the determined target layer to generate the target map.

11. A control method comprising:
generating a target map, based on receiving at least one unit map;
determining at least one waypoint corresponding to the at least one unit map included in the target map; and
generating a driving path of a robot based on a connected graph determined based on the at least one waypoint.

12. The control method of claim 11, wherein generating the driving path of the robot includes:
identifying at least one of coordinates of an obstacle included in each of the at least one unit map, location coordinates of each of the at least one unit map, image data of each of the at least one unit map, or a combination thereof; and
connecting the at least one unit map based on the at least one of the coordinates of the obstacle, the location coordinates, the image data, or the combination thereof.

13. The control method of claim 12, wherein generating the driving path of the robot includes:
after providing the at least one unit map, transmitting an approval request to a user;
generating the target map based on receiving approval from the user; and
applying error information of the target map to the at least one unit map to generate the target map based on receiving the error information from the user.

14. The control method of claim 11, wherein generating the driving path of the robot includes:
identifying a first point about a current location of the robot and a second point about a target location of the robot based on the target map;
applying the target map, the first point, and the second point to a path prediction model trained to predict a path to obtain a temporary path; and
obtaining a region of interest from the target map to which the robot is movable based on the target map and the temporary path.

15. The control method of claim 14, wherein generating the driving path of the robot includes:
determining a target region which is a connect region of at least two unit maps on basis of the region of interest based on a size of the robot and a function of the robot; and
determining a predetermined point of the target region as the at least one waypoint.

16. The control method of claim 11, wherein generating the driving path of the robot includes determining the connected graph in which each of the at least one unit map is applied to a node and the at least one waypoint is applied to an edge between the nodes based on determining the at least one waypoint.

17. The control method of claim 16, wherein generating the driving path of the robot includes:
identifying a reference unit map including a target location of the robot from the at least one unit map;
identifying a comparison unit map adjacent to the reference unit map via the at least one waypoint; and
deleting the at least one waypoint between the comparison unit map and the reference unit map based on identifying that it is impossible for the robot to move from the at least one waypoint between the comparison unit map and the reference unit map to the target location based on an obstacle included in the reference unit map.

18. The control method of claim 16, wherein generating the driving path of the robot includes:
determining a weight of the edge included in the connected graph based on at least one of a speed of the robot, energy consumption of the robot, safety of the robot, a priority of each of the at least one unit map, or a combination thereof; and
generating the driving path based on a path score obtained by applying the connected graph in which the weight is determined to a predetermined path algorithm.

19. The control method of claim 11, wherein generating the driving path of the robot includes:
controlling the robot to move along the driving path based on generating the driving path;
receiving obstacle information for performing an update of the target map;
re-determining the at least one waypoint based on the target map; and
performing the update.

20. The control method of claim 11, wherein generating the driving path of the robot includes:
determining a target layer among a plurality of layers for at least two unit maps; and
connecting the at least two maps for the determined target layer to generate the target map.
